(19) United States
(12) Patent Application Publication
(10) Pub. No.: US 2026/0088517 A1
(43) Pub. Date: Mar. 26, 2026

(54) ANTENNA DEVICE WITH ADJACENT RADIATING PORTIONS FORMED ON A CONDUCTIVE LAYER

(71) Applicant: MEDIATEK INC., Hsinchu City (TW)

(72) Inventor: Chung-Hsin Chiang, Hsinchu City (TW)

(73) Assignee: MEDIATEK INC., Hsinchu City (TW)

(21) Appl. No.: 19/324,176

(22) Filed: Sep. 10, 2025

Related U.S. Application Data
(60) Provisional application No. 63/698,094, filed on Sep. 24, 2024.

(51) Int. Cl. H01Q 21/06

(52) U.S. Cl. CPC H01Q 21/064

(57) ABSTRACT

An antenna device may include a first conductive portion, a second conductive portion, a first radiating portion, and a second radiating portion. The first conductive portion is formed at an upper region of a first conductive layer. The second conductive portion is formed at a lower region of the first conductive layer. The first radiating portion is formed at a left region of the first conductive layer. The second radiating portion is formed at a right region of the first conductive layer. The first conductive layer has a first slot formed between the first conductive portion and the first radiating portion, and a second slot formed between the second conductive portion and the first radiating portion.

### CROSS REFERENCE TO RELATED APPLICATIONS

This application claims the benefit of U.S. Provisional Application No. 63/698,094, filed on September 24th, 2024. The content of the application is incorporated herein by reference.

### BACKGROUND

The increasing use of wireless communication applications has driven greater demand for antenna technologies. In current multi-input multi-output (MIMO) antenna designs, adequate spacing between antenna elements is typically necessary, and specialized ground slots must be implemented to achieve proper decoupling. When these design requirements are not met, maintaining sufficient isolation becomes difficult, leading to unwanted interference problems.

Although existing antenna structures remain functional, they present significant design limitations. These structural constraints make it challenging to reduce overall antenna size, which creates difficulties when integrating antennas into compact products such as portable devices. Moreover, expanding antenna bandwidth faces technical barriers that are becoming increasingly difficult to address with current design methods.

### SUMMARY

An embodiment provides an antenna device including a first conductive portion, a second conductive portion, a first radiating portion, and a second radiating portion. The first conductive portion is formed at an upper region of a first conductive layer. The second conductive portion is formed at a lower region of the first conductive layer. The first radiating portion is formed at a left region of the first conductive layer. The second radiating portion is formed at a right region of the first conductive layer. The first conductive layer has a first slot formed between the first conductive portion and the first radiating portion, and a second slot formed between the second conductive portion and the first radiating portion.

Another embodiment provides an antenna device including a first radiating portion, a second radiating portion, a first conductive portion, and a second conductive portion. The first radiating portion is formed at a left region of a first conductive layer. The second radiating portion is formed at a right region of the first conductive layer. The first conductive portion is formed at an upper region of a second conductive layer below the first conductive layer. The second conductive portion is formed at a lower region of the second conductive layer. A right side of the first radiating portion has a plurality of edges parallel to corresponding edges at a left side of the first conductive portion and a left side of the second conductive portion to form a first narrow slit. A left side of the second radiating portion has a plurality of edges parallel to corresponding edges at a right side of the first conductive portion and a right side of the second conductive portion to form a second narrow slit. A projection of at least one of the first radiating portion and the second radiating portion overlaps with at least one of the first conductive portion and the second conductive portion.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an antenna device according to an embodiment.

FIG. 2 illustrates a side view of the antenna device, as seen from direction D1 in FIG. 1.

FIG. 3 illustrates an antenna device according to another embodiment.

FIG. 4 illustrates an antenna device according to another embodiment.

FIG. 5 illustrates an antenna device according to another embodiment.

FIG. 6 illustrates an antenna device according to another embodiment.

FIG. 7 illustrates a perspective view of a portion of an antenna device according to another embodiment.

FIG. 8 illustrates a perspective view of a portion of an antenna device.

FIG. 9 and FIG. 10 illustrate an antenna device according to another embodiment.

FIG. 11 illustrates an antenna device according to another embodiment.

FIG. 12 illustrates an antenna device according to another embodiment.

### DETAILED DESCRIPTION

As used herein, when element A is described as "coupled to" element B, such coupling may be direct coupling or indirect coupling through other suitable components. Suitable components may include, but are not limited to, appropriately incorporated passive elements. As used herein, when A is described as "including" B or "comprising" B, it means that A includes but is not limited to B. As used herein, an antenna radiator may be referred to as an "antenna" or a "radiator." As used herein, when "and/or" is used to connect two elements, it indicates the inclusion of at least one of the two elements or any reasonable combination thereof. For example, "A and/or B" encompasses the scenarios of A only, B only, and both A and B. As used herein, "radiation direction" refers to the directional characteristics of an antenna when accessing wireless signals, where the radiation direction relates to the antenna's radiation pattern. As used herein, "accessing" a signal may include receiving a signal and/or transmitting a signal. As used herein, a via may be a conductive structure that may be formed by drilling and filling with conductive material, or formed by other methods, to provide a conductive path in a vertical direction. For example, a via may provide a conductive path between different layers and may have a cylindrical shape or other suitable forms. As used herein, when A is described as "mirroring" B, it indicates that A can be formed based on B, where A and B can have substantially the same shape and area, but appropriate modifications to A remain within the scope of embodiments. As used herein, when A and B are described as overlapping, it indicates that the projections of A and B overlap, where A and B may or may not be in contact.

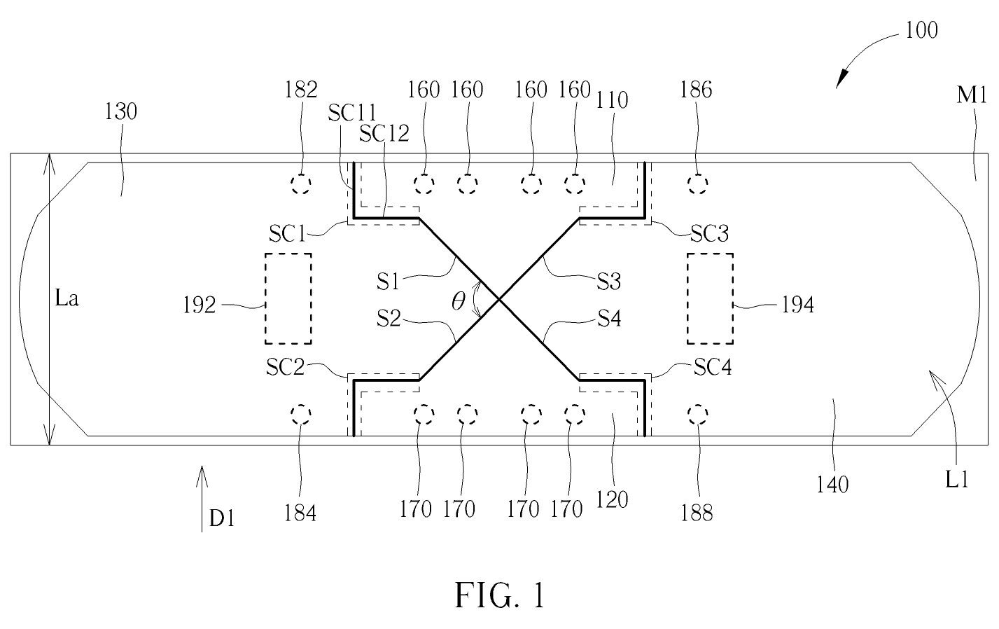

FIG.1 illustrates an antenna device 100 according to an embodiment. The antenna device 100 may include a first conductive portion 110, a second conductive portion 120, a first radiating portion 130, and a second radiating portion 140.

The first conductive portion 110 may be formed at an upper region of a first conductive layer L1. The second conductive portion 120 may be formed at a lower region of the first conductive layer L1. The first radiating portion 130 may be formed at a left region of the first conductive layer L1. The second radiating portion 140 may be formed at a right region of the first conductive layer L1.

The first conductive layer L1 may have a first slot S1 formed between the first conductive portion 110 and the first radiating portion 130, and a second slot S2 formed between the second conductive portion 120 and the first radiating portion 130. Additionally, the first conductive layer L1 may have a third slot S3 formed between the first conductive portion 110 and the second radiating portion 140, and a fourth slot S4 formed between the second conductive portion 120 and the second radiating portion 140.

As shown in FIG. 1, the first conductive layer L1 may be a metal layer. The antenna device 100 may further include a layer M1. The layer M1 may be a non-conductive layer, such as a dielectric material layer, a plastic layer, or other suitable layers. The first conductive layer L1 may be embedded in the layer M1, and the layer M1 may support the first conductive layer L1.

In the structure of FIG. 1, a single antenna device 100 may have two radiators (e.g., the first radiating portion 130 and the second radiating portion 140). The first radiating portion 130 and the second radiating portion 140 may be closely adjacent and positioned side by side. Therefore, the overall structure can be compact, avoiding the size reduction challenges caused by the need to maintain large spacing between two radiators.

As shown in FIG. 1, each of the first slot S1, the second slot S2, the third slot S3, and the fourth slot S4 may have a first terminal and a second terminal. The second terminal of the first slot S1 may be connected to the first terminal of the second slot S2. The second terminal of the third slot S3 may be connected to the first terminal of the fourth slot S4. As shown in FIG. 1, the second terminal of the first slot S1, the first terminal of the second slot S2, the second terminal of the third slot S3, and the first terminal of the fourth slot S4 may be connected, so that the first slot S1, the second slot S2, the third slot S3, and the fourth slot S4 may form an X-shaped structure. However, embodiments are not limited thereto, and other embodiments will be described hereinafter.

As shown in FIG. 1, the first slot S1 and the second slot S2 may form an angle θ between 85 degrees and 95 degrees. For example, the angle θ may be substantially a right angle to provide sufficient isolation between the first radiating portion 130 and the second radiating portion 140, and to cancel unwanted signal leakage.

In FIG. 1, the first slot S1 may be parallel to the fourth slot S4, and the third slot S3 may be parallel to the second slot S2, but embodiments are not limited thereto.

As shown in FIG.1, the antenna device 100 may further include a first capacitive slot SC1 connected to an upper side of the first conductive layer L1 and the first slot S1 for generating a first capacitive coupling. The antenna device 100 may further include a second capacitive slot SC2 connected to a lower side of the first conductive layer L1 and the second slot S2 for generating a second capacitive coupling. The aforementioned first capacitive coupling and second capacitive coupling may adjust resonant frequencies, improve impedance matching, increase bandwidth, provide decoupling effects, and enhance isolation performance.

Similar to the first capacitive slot SC1 and the second capacitive slot SC2, the antenna device 100 may further include a third capacitive slot SC3 and a fourth capacitive slot SC4 to enhance capacitive coupling. The aforementioned capacitive slots (e.g. SC1, SC2, SC3, SC4) may have appropriate shapes. If the slots include more meandering structures, the meandering structures can achieve longer effective slot lengths. Therefore, this may correspond to lower operating frequencies. Alternatively, if the operating frequency remains unchanged, the length La can be reduced.

As shown in FIG. 1, the first capacitive slot SC1 may include a first portion SC11 connected to the upper side of the first conductive layer L1, and a second portion SC12 connected to the first portion SC11 and the first slot S1. The first portion SC11 and the second portion SC12 may form an L-shaped structure. However, this is merely exemplary, and embodiments are not limited thereto.

As shown in FIG. 1, the antenna device 100 may further include a plurality of first conductive vias 160 each having a first terminal connected to the first conductive portion 110 and a second terminal connected to a reference voltage terminal (such as but not limited to a ground terminal). The antenna device 100 may further include a plurality of second conductive vias 170 each having a first terminal connected to the second conductive portion 120 and a second terminal connected to the reference voltage terminal. The first conductive vias 160 and the second conductive vias 170 may be used to provide shorting paths, improve isolation, operate with the slots to achieve decoupling, and provide structural support to enhance reliability.

As shown in FIG. 1, the antenna device 100 can further include edge vias 182, 184, 186 and 188. Each of the edge vias 182 and 184 can include a first terminal coupled to the first radiating portion 130 and a second terminal coupled to a reference voltage terminal (such as but not limited to a ground terminal). Each of the edge vias 186 and 188 can include a first terminal coupled to the second radiating portion 140 and a second terminal coupled to the reference voltage terminal (such as but not limited to a ground terminal). As shown in FIG.1, the first conductive vias 160, the second conductive vias 170, and the edge vias 182, 184, 186 and 188 may be formed below the first conductive layer L1.

As shown in FIG. 1, the antenna device 100 may further include a first feeding element 192 and a second feeding element 194. The first feeding element 192 may be formed below the first conductive layer L1 and coupled to the first radiating portion 130. The second feeding element 194 may be formed below the first conductive layer L1 and coupled to the second radiating portion 140. The first feeding element 192 and the second feeding element 194 may be used to transmit signals, enabling the first radiating portion 130 and the second radiating portion 140 to transmit wireless signals. Additionally, wireless signals received by the first radiating portion 130 and the second radiating portion 140 may be converted to corresponding signals and transmitted through the first feeding element 192 and the second feeding element 194 to appropriate circuits. According to some embodiments, the first feeding element 192 and the second feeding element 194 maybe used to transmit and receive a pair of MIMO (Multiple-Input Multiple-Output) signals. Here, MIMO signals may be signals transmitted and received simultaneously using a plurality of antennas within the same frequency band, which can be utilized to enhance data transmission rates and reliability in wireless communications.

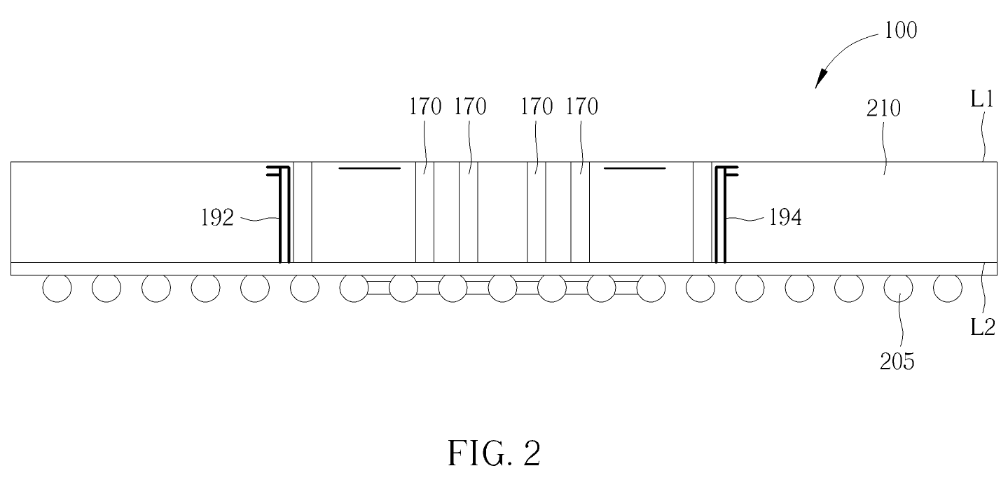

FIG. 2 illustrates a side view of the antenna device 100, as seen from direction D1 in FIG. 1. The first conductive layer L1 may be located at an upper layer. A second conductive layer L2 may be a predetermined voltage layer, such as but not limited to a ground layer. The second conductive vias 170 may be in a cylindrical form or other suitable forms. In the example of FIG.2, the first feeding element 192 and the second feeding element 194 are not directly connected to the first radiating portion 130 and the second radiating portion 140, so feeding is achieved through capacitive coupling, but embodiments are not limited thereto. The antenna device 100 may include a plurality of conductive interfaces 205. The conductive interfaces 205 may be solder balls, contact pads, conductive bumps, wire bonds, or other suitable packaging interfaces. A layer 210 between the first conductive layer L1 and the second conductive layer L2 may be a non-conductive layer. The layer 210 may use dielectric materials or other suitable materials and may be formed by molding, injection molding, lamination, or other methods. The antenna device 100 may be formed using packaging processes, printed circuit board (PCB) processes, or suitable multi-layer processes.

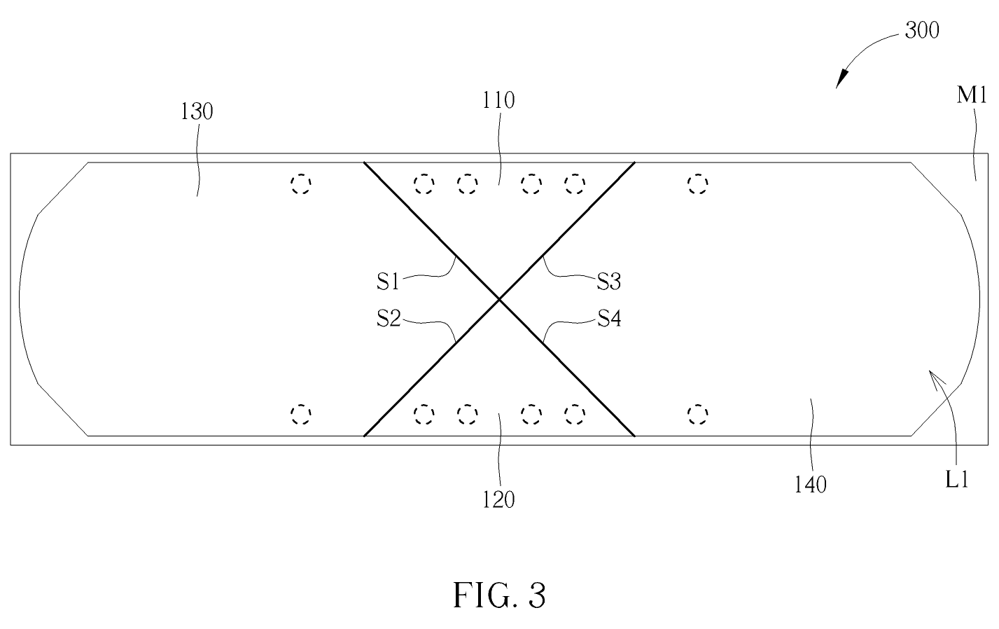

FIG. 3 illustrates an antenna device 300 according to another embodiment. The antenna device 300 may be similar to the antenna device 100, and similar aspects are not repeated herein. However, the antenna device 300 may not include the first capacitive slot SC1, the second capacitive slot SC2, the third capacitive slot SC3, and the fourth capacitive slot SC4 of FIG. 1. Since the capacitive slots are omitted, the overall slot length may be reduced and may correspond to higher operating frequencies.

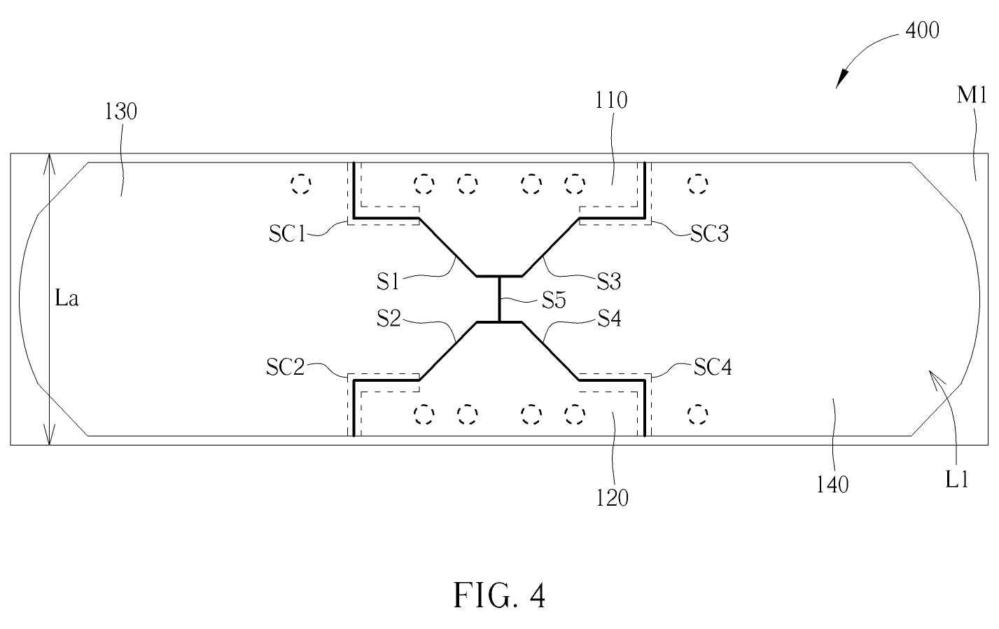

FIG. 4 illustrates an antenna device 400 according to another embodiment. The similarities between the antenna device 400 and the antenna device 100 are not repeated, but the antenna device 400 may further include a fifth slot S5. The fifth slot S5 may be formed between the first radiating portion 130 and the second radiating portion 140. The fifth slot S5 may have a first terminal and a second terminal. The first terminal of the fifth slot S5 may be connected to the second terminal of the first slot S1 and the second terminal of the third slot S3. The second terminal of the fifth slot S5 may be connected to the first terminal of the second slot S2 and the first terminal of the fourth slot S4. In FIG. 4, the first slot S1, the second slot S2, the third slot S3, and the fourth slot S4 may not form the aforementioned X-shape. Using the slot arrangement of FIG. 4, the length of the slot path may be increased. For example, the combined length of the first slot S1, the fifth slot S5, and the second slot S2 may be greater than the combined length of the first slot S1 and the second slot S2 in FIG. 1, thereby enabling a reduction in resonant frequency. Alternatively, when maintaining the resonant frequency, the length La may be reduced. The first capacitive slot SC1, the second capacitive slot SC2, the third capacitive slot SC3, and the fourth capacitive slot SC4 in FIG. 4 may be selectively formed or not formed. As shown in FIG. 4, each of the first slot S1, the second slot S2, the third slot S3, and the fourth slot S4 may be non-linear and include bends, but embodiments are not limited to this example in FIG. 4. Each of the first slot S1, the second slot S2, the third slot S3, and the fourth slot S4 may also be linear.

In FIG. 4, the length of the fifth slot S5 may be smaller than a threshold to avoid excessive interference between the first radiating portion 130 and the second radiating portion 140, wherein the threshold may be a predetermined length, one of the first slot S1 to the fourth slot S4 multiplied by a ratio, or a multiple of a signal wavelength.

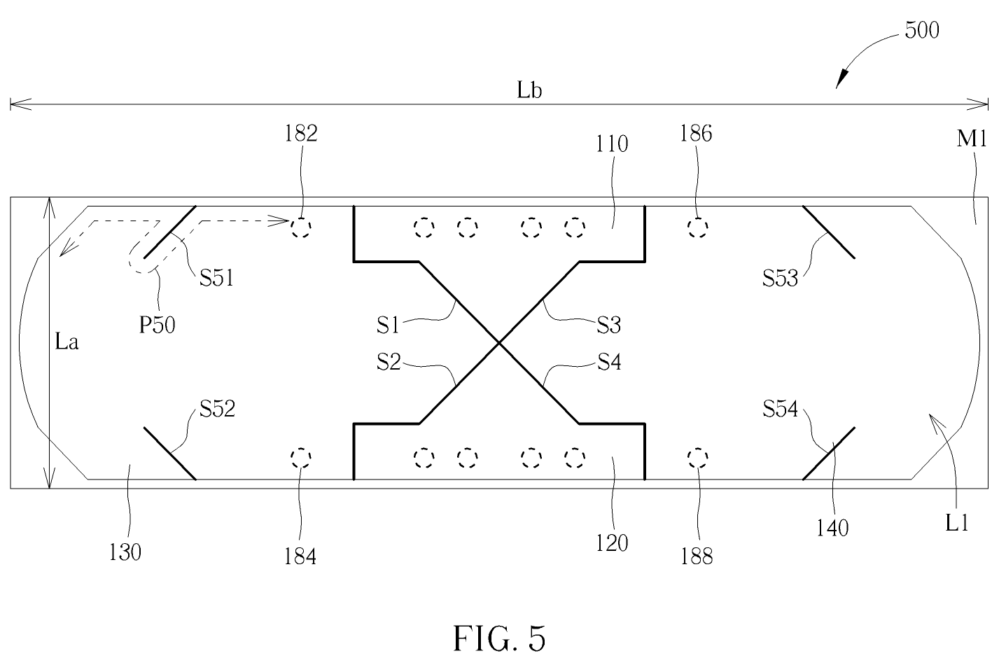

FIG. 5 illustrates an antenna device 500 according to another embodiment. The similarities between the antenna device 500 and the aforementioned antenna device 100 are not repeated. In the antenna device 500, the first conductive layer L1 may further have a first auxiliary slot S51 and a second auxiliary slot S52. The first auxiliary slot S51 may be connected to an upper side of the first conductive layer L1, and the second auxiliary slot S52 may be connected to a lower side of the first conductive layer L1. The first auxiliary slot S51 and the second auxiliary slot S52 may be formed on the first radiating portion 130. Similarly, the antenna device 500 may have a third auxiliary slot S53 and a fourth auxiliary slot S54 formed on the second radiating portion 140.

Taking the first auxiliary slot S51 as an example, if the first auxiliary slot S51 is formed and used, current may flow along the first auxiliary slot S51, thereby extending the path P50. Therefore, when maintaining the resonant frequency, the length Lb of the antenna device 500 may be reduced. In FIG. 5, the slots other than the first auxiliary slot S51, the second auxiliary slot S52, the third auxiliary slot S53, and the fourth auxiliary slot S54 are similar to those in FIG. 1, but FIG. 5 is merely exemplary. In the aforementioned antenna devices 300 and 400, one or more of the first auxiliary slot S51, the second auxiliary slot S52, the third auxiliary slot S53, and the fourth auxiliary slot S54 may also be selectively formed to adjust performance.

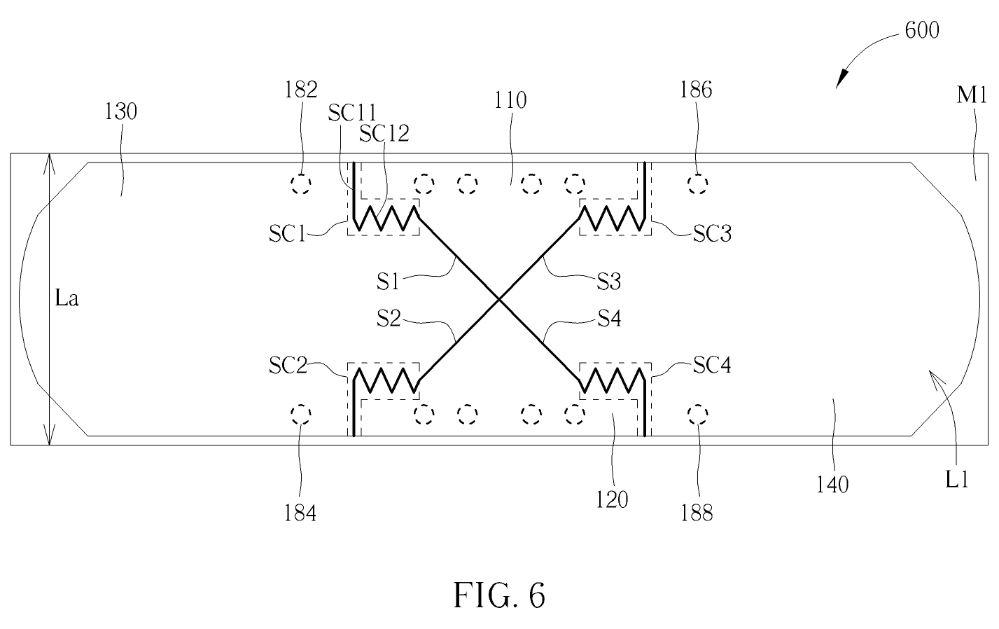

FIG. 6 illustrates an antenna device 600 according to another embodiment. The similarities between the antenna device 600 and the aforementioned antenna devices are not repeated. As shown in FIG. 6, at least one of the first portion SC11 and the second portion SC12 of the first capacitive slot SC1 may have a straight or zigzag shape. In FIG. 6, the second portion SC12 has a zigzag shape. However, FIG.6 is merely exemplary. The first portion SC11 may have a zigzag shape while the second portion SC12 is straight, or both the first portion SC11 and the second portion SC12 may have zigzag shapes, which is also within the scope of embodiments.

The above description uses the first capacitive slot SC1 as an example. The second capacitive slot SC2, the third capacitive slot SC3, and the fourth capacitive slot SC4 may also have zigzag shapes. Using the zigzag-shaped slots of FIG. 6 may increase the total length of the slots. For example, the combined length of the first capacitive slot SC1, the first slot S1, the second slot S2, and the second capacitive slot SC2 can be increased. Therefore, the length La can be reduced when maintaining the resonant frequency. Additionally, coupling can be increased.

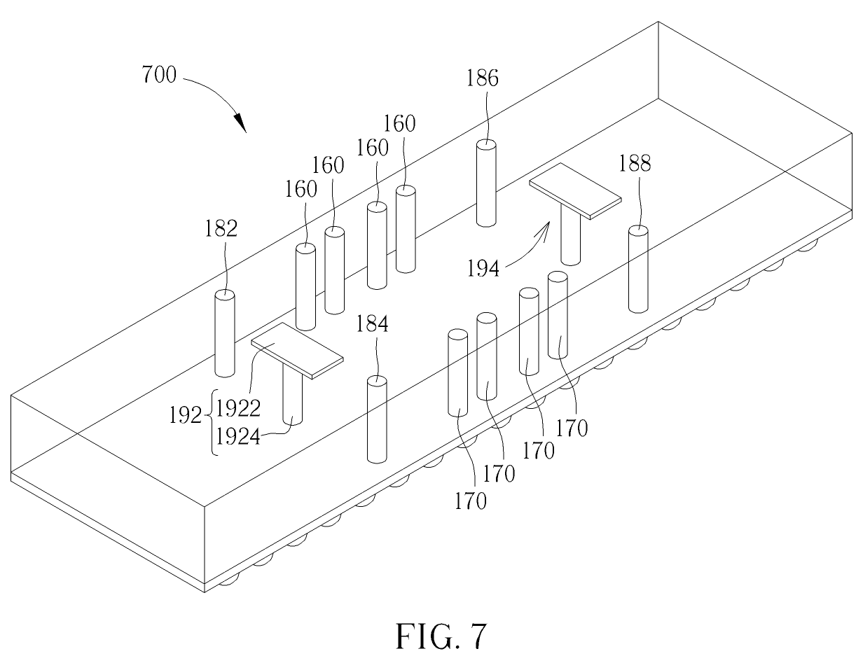

FIG. 7 illustrates a perspective view of a portion of an antenna device 700 according to another embodiment. The structure of the antenna device 700 may be applied to the aforementioned antenna devices 100 and 300 to 600.FIG. 7 does not show the first conductive layer L1 mentioned above to avoid obscuring the components being described. FIG. 7 shows the first conductive vias 160, the second conductive vias 170, the edge vias 182, 184, 186, and 188, the first feeding element 192, and the second feeding element 194. In FIG. 7, taking the first feeding element 192 as an example, the first feeding element 192 may include a horizontal conductive portion 1922 and a vertical conductive portion 1924. The vertical conductive portion 1924 may include a first terminal connected to the horizontal conductive portion 1922 and a second terminal connected to a predetermined circuit or a predetermined voltage terminal (such as but not limited to a transceiver terminal). For example, the second terminal of the vertical conductive portion 1924 may be connected to a radio-frequency integrated circuit (RFIC). The second feeding element 194 is similar to the first feeding element 192, so the description is not repeated. The horizontal conductive portion 1922 in FIG. 7 may be rectangular, but embodiments are not limited to this structure.

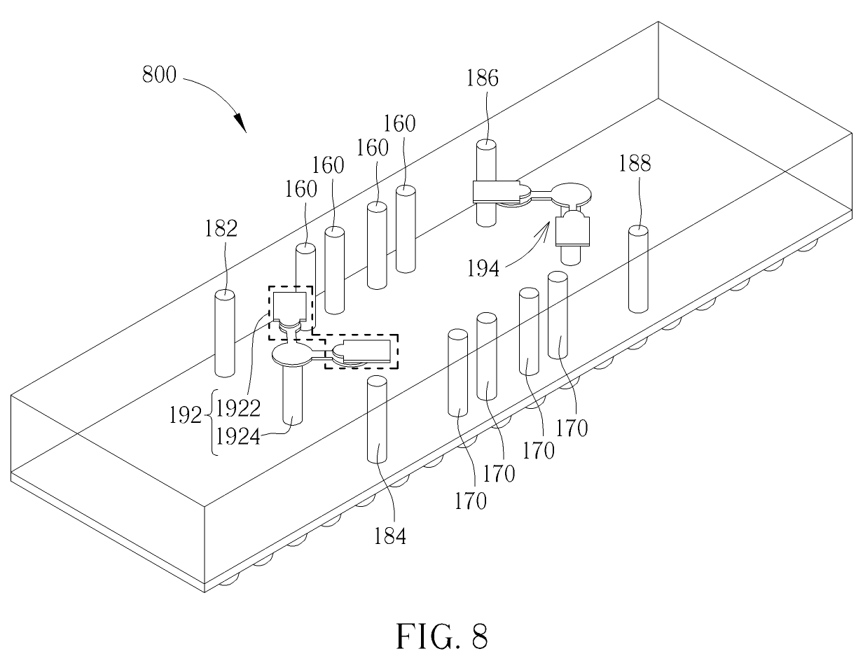

FIG. 8 illustrates a perspective view of a portion of an antenna device 800. The similarities between the antenna device 800 and the antenna device 700 are not repeated. In the antenna device 800, the first feeding element 192 may include a horizontal conductive portion 1922 and a vertical conductive portion 1924, where the horizontal conductive portion 1922 may include two conductive parts to form an L-shape.

If impedance matching is acceptable, the first feeding element 192 and the second feeding element 194 may directly contact the first radiating portion 130 and the second radiating portion 140 to provide direct feeding. In another embodiment, the first feeding element 192 and the second feeding element 194 may not directly contact the first radiating portion 130 and the second radiating portion 140 to provide coupling feeding through capacitive coupling.

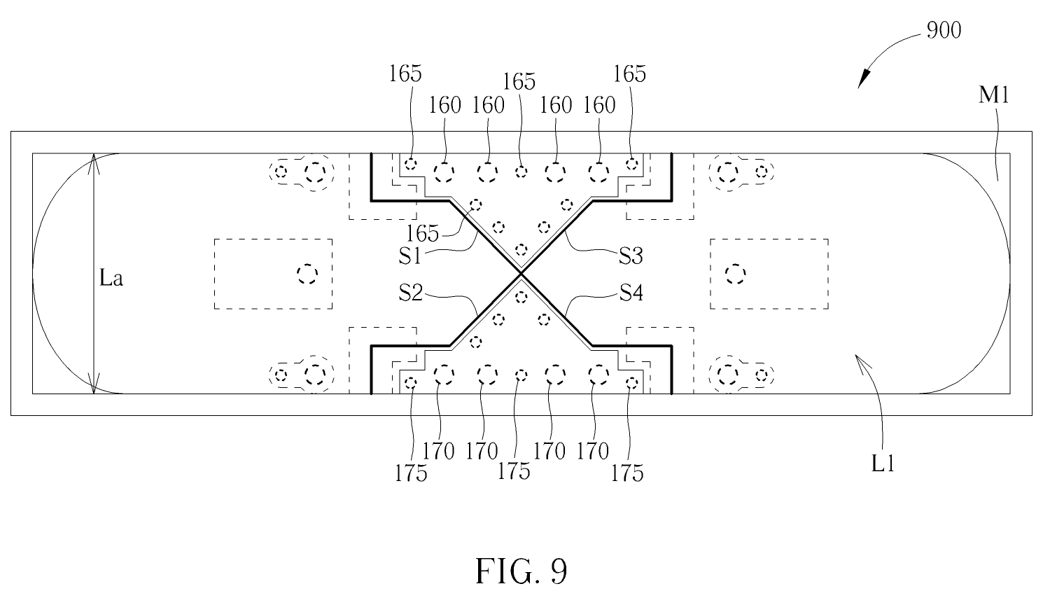

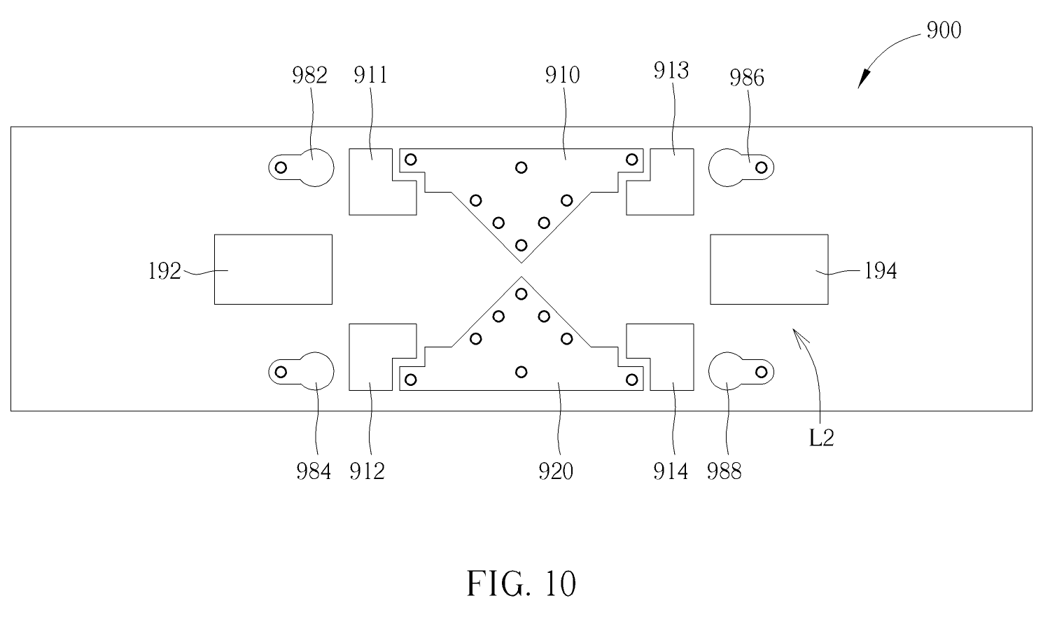

FIG. 9 and FIG. 10 illustrate an antenna device 900 according to another embodiment. FIG. 9 shows the structure as observed from the first conductive layer L1. FIG. 10 shows the structure of a second conductive layer L2 below the first conductive layer L1. The similarities between the antenna device 900 and the antenna device 100 are not repeated. The antenna device 900 may have a multi-layer structure with the second conductive layer L2 below the first conductive layer L1. In the antenna device 900, in addition to the first conductive vias 160, a plurality of conductive vias 165 may be formed below the first conductive portion 110 to connect to a first auxiliary conductive portion 910 formed on the second conductive layer L2 below the first conductive layer L1. The first auxiliary conductive portion 910 may have a shape mirroring the first conductive portion 110. Similarly, in addition to the second conductive vias 170, a plurality of conductive vias 175 may be formed below the second conductive portion 120 to connect to a second auxiliary conductive portion 920 formed on the second conductive layer L2. The second auxiliary conductive portion 920 may have a shape mirroring the second conductive portion 120.

The antenna device 900 may further include capacitive coupling conductive portions 911, 912, 913, and 914 formed on the second conductive layer L2. The capacitive coupling conductive portion 911 may have a shape mirroring the first capacitive slot SC1. The capacitive coupling conductive portion 912 may have a shape mirroring the second capacitive slot SC2. The capacitive coupling conductive portion 913 may have a shape mirroring the third capacitive slot SC3. The capacitive coupling conductive portion 914 may have a shape mirroring the fourth capacitive slot SC4.

The antenna device 900 may further include conductive elements 982, 984, 986, and 988 formed on the second conductive layer L2 and respectively connected to the aforementioned edge vias 182, 184, 186, and 188.

The multi-layer structure of FIG. 9 and FIG. 10 can increase the vertical equivalent coupling capacitance of the antenna device 900 in the normal direction of the first conductive layer L1. Therefore, the required slot length can be reduced. As a result, the length La can be decreased, contributing to compactness.

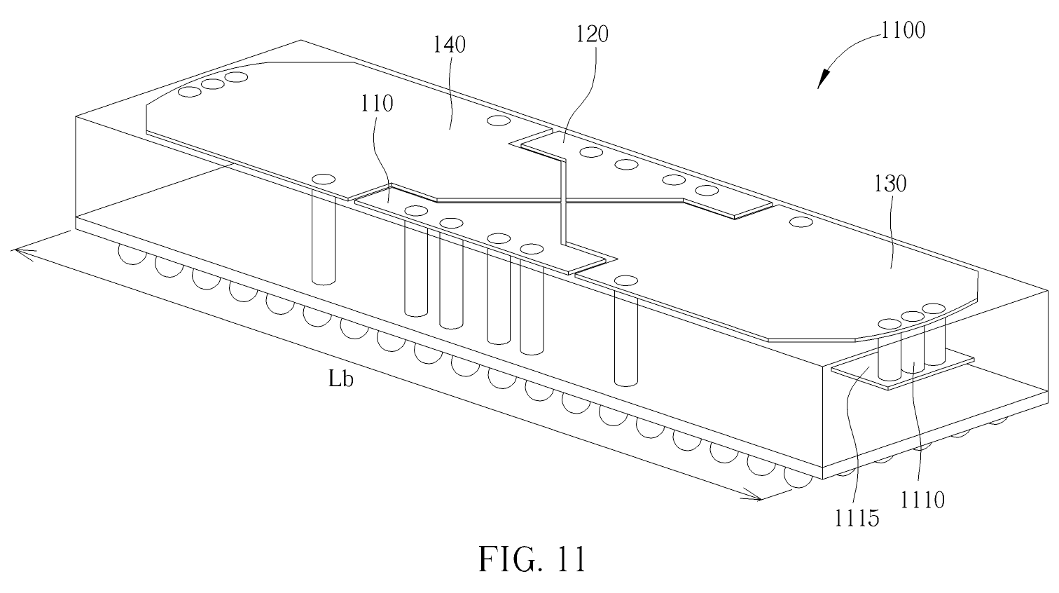

FIG. 11 illustrates an antenna device 1100 according to another embodiment. FIG. 11 is a perspective view. The similarities between the antenna device 1100 and the antenna device 100 are not repeated. The antenna device 1100 may further include a plurality of conductive pillars 1110 formed below the first conductive layer L1. Each of the conductive pillars 1110 may have a first terminal connected to a related radiating portion (e.g., one of the first radiating portion 130 and the second radiating portion 140) and a second terminal. The antenna device 1100 may further include a horizontal conductive sheet 1115 formed below the plurality of conductive pillars 1110 and connected to the plurality of conductive pillars 1110. The horizontal conductive sheet 1115 may be parallel to the first conductive layer L1. The horizontal conductive sheet 1115 may be selectively formed or not formed according to requirements, both of which are within the scope of the embodiments.

In FIG. 11, the conductive pillars 1110 and the horizontal conductive sheet 1115 associated with the first radiating portion 130 are more clearly shown, but similar structures may also be formed below the second radiating portion 140. Since current may flow along the conductive pillars 1110 and the horizontal conductive sheet 1115, the structure of FIG. 11 can reduce the length Lb when maintaining the resonant frequency.

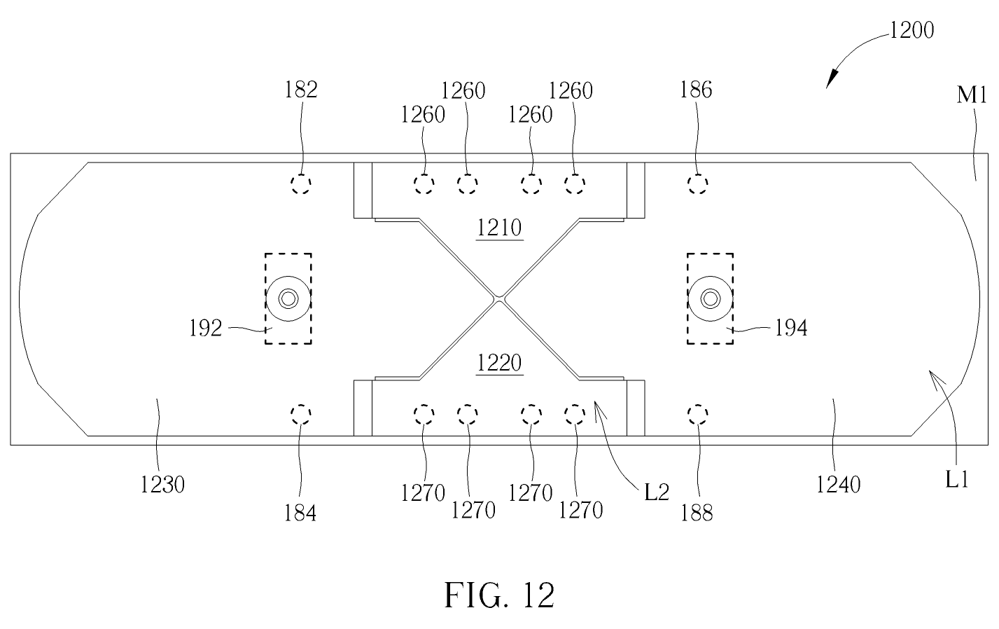

FIG. 12 illustrates an antenna device 1200 according to another embodiment. The antenna device 1200 may include a first radiating portion 1230, a second radiating portion 1240, a first conductive portion 1210, and a second conductive portion 1220. The first radiating portion 1230 may be formed at a left region of a first conductive layer L1. The second radiating portion 1240 may be formed at a right region of the first conductive layer L1. The first conductive portion 1210 may be formed at an upper region of a second conductive layer L2 below the first conductive layer L1. The second conductive portion 1220 may be formed at a lower region of the second conductive layer L2. A right side of the first radiating portion 1230 may have a plurality of edges parallel to corresponding edges at a left side of the first conductive portion 1210 and a left side of the second conductive portion 1220 to form a first narrow slit. A left side of the second radiating portion 1240 may have a plurality of edges parallel to corresponding edges at a right side of the first conductive portion 1210 and a right side of the second conductive portion 1220 to form a second narrow slit. A projection of at least one of the first radiating portion 1230 and the second radiating portion 1240 may overlap with at least one of the first conductive portion 1210 and the second conductive portion 1220. In the antenna device 1200, a plurality of conductive vias 1260 may be formed below the first conductive portion 1210 between the first conductive portion 1210 and a predetermined voltage terminal (such as a ground terminal), and a plurality of conductive vias 1270 may be formed below the second conductive portion 1220 between the second conductive portion 1220 and the predetermined voltage terminal.

Unlike FIG. 1, the antenna device 1200 may not include the first conductive portion 110 and the second conductive portion 120 formed on the first conductive layer L1. In the antenna device 1200, the narrow slits between the first conductive layer L1 and the second conductive layer L2 formed with the first conductive portion 1210, the second conductive portion 1220, the first radiating portion 1230, and the second radiating portion 1240 may be used as slots to access wireless signals. Adjusting the dimensions of the narrow slits (such as length, distance between the first conductive layer L1 and the second conductive layer L2, overlapping area between the first conductive portion 1210 and the first radiating portion 1230, etc.) may adjust the corresponding frequency bands and radiation patterns.

In summary, the antenna devices 100, 300 to 900, 1100, and 1200 provided by the embodiments can avoid having a large gap between two radiating portions of the antenna, thereby effectively reducing the antenna size. Additionally, the various antenna devices described above teach different structures to further reduce the antenna size. One or more of the conductive portions 110, 120, conductive vias 160, 170, edge vias 182, 184, 186, 188, conductive pillars 1110, horizontal conductive sheet 1115, and conductive vias 1260, 1270 may be formed according to specific requirements to provide shorting paths, improve isolation, cancel unwanted signal leakage, operate with the slots to achieve decoupling, and provide structural support to enhance reliability. Using the aforementioned structures can effectively reduce the antenna size, improve isolation, and increase bandwidth. Furthermore, the aforementioned antenna devices are applicable to substrate processes, printed circuit board (e.g., PCB) processes, and package processes. Since compactness can be improved, this facilitates integration into portable devices. Therefore, this is beneficial for realizing compact broadband MIMO antennas.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An antenna device, comprising:
a first conductive portion formed at an upper region of a first conductive layer;
a second conductive portion formed at a lower region of the first conductive layer;
a first radiating portion formed at a left region of the first conductive layer; and
a second radiating portion formed at a right region of the first conductive layer;
wherein the first conductive layer has a first slot formed between the first conductive portion and the first radiating portion, and a second slot formed between the second conductive portion and the first radiating portion.

2. The antenna device of claim 1, wherein the first slot and the second slot form an angle between 85 degrees and 95 degrees.

3. The antenna device of claim 1, wherein the first slot has a first terminal and a second terminal, the second slot has a first terminal and a second terminal, and the second terminal of the first slot is connected to the first terminal of the second slot.

4. The antenna device of claim 1, wherein the first conductive layer has a third slot formed between the first conductive portion and the second radiating portion, and a fourth slot formed between the second conductive portion and the second radiating portion.

5. The antenna device of claim 4, wherein the third slot has a first terminal and a second terminal, the fourth slot has a first terminal and a second terminal, and the second terminal of the third slot is connected to the first terminal of the fourth slot.

6. The antenna device of claim 4, wherein:
the first conductive layer has a fifth slot formed between the first radiating portion and the second radiating portion, the fifth slot having a first terminal and a second terminal; and
the first terminal of the fifth slot is connected to the first slot and the third slot, and the second terminal of the fifth slot is connected to the second slot and the fourth slot.

7. The antenna device of claim 1, wherein the first conductive layer has a first capacitive slot connected to an upper side of the first conductive layer and the first slot for generating a first capacitive coupling, and a second capacitive slot connected to a lower side of the first conductive layer and the second slot for generating a second capacitive coupling.

8. The antenna device of claim 7, wherein the first capacitive slot has a first portion connected to the upper side of the first conductive layer, and a second portion connected to the first portion and the first slot.

9. The antenna device of claim 8, wherein at least one member of a group comprising the first portion and the second portion of the first capacitive slot has a straight or zigzag shape.

10. The antenna device of claim 7, further comprising:
a first capacitive coupling conductive portion formed on a second conductive layer below the first conductive layer, and having a shape mirroring the first capacitive slot.

11. The antenna device of claim 10, further comprising:
a second capacitive coupling conductive portion formed on the second conductive layer below the first conductive layer, and having a shape mirroring the second capacitive slot.

12. The antenna device of claim 1, further comprising:
a first auxiliary conductive portion formed on a second conductive layer below the first conductive layer, and having a shape mirroring the first conductive portion; and
a second auxiliary conductive portion formed on the second conductive layer below the first conductive layer, and having a shape mirroring the second conductive portion.

13. The antenna device of claim 1, further comprising:
a plurality of first conductive vias each having a first terminal connected to the first conductive portion and a second terminal connected to a reference voltage terminal; and
a plurality of second conductive vias each having a first terminal connected to the second conductive portion and a second terminal connected to the reference voltage terminal.

14. The antenna device of claim 1, wherein the first conductive layer has a first auxiliary slot connected to an upper side of the first conductive layer, and a second auxiliary slot connected to a lower side of the first conductive layer.

15. The antenna device of claim 1, further comprising:
a first feeding element formed below the first conductive layer and coupled to the first radiating portion; and
a second feeding element formed below the first conductive layer and coupled to the second radiating portion;
wherein the first feeding element and the second feeding element are configured to transmit and receive a pair of MIMO signals.

16. The antenna device of claim 15, wherein the first feeding element comprises:
a horizontal conductive portion; and
a vertical conductive portion including a first terminal connected to the horizontal conductive portion and a second terminal connected to a predetermined circuit or a predetermined voltage terminal.

17. The antenna device of claim 16, wherein the horizontal conductive portion has a rectangular or L shape.

18. The antenna device of claim 1, further comprising:
a plurality of conductive pillars each formed below the first radiating portion and having a first terminal connected to the first radiating portion and a second terminal.

19. The antenna device of claim 18, further comprising:
a horizontal conductive sheet formed below the plurality of conductive pillars and connected to the plurality of conductive pillars.

20. The antenna device of claim 1, further comprising:
a first edge via comprising a first terminal connected to the first radiating portion and a second terminal connected to a reference voltage terminal; and
a second edge via comprising a first terminal connected to the second radiating portion and a second terminal connected to a reference voltage terminal.

21. An antenna device, comprising:
a first radiating portion formed at a left region of a first conductive layer;
a second radiating portion formed at a right region of the first conductive layer;
a first conductive portion formed at an upper region of a second conductive layer below the first conductive layer; and
a second conductive portion formed at a lower region of the second conductive layer;
wherein a right side of the first radiating portion has a plurality of edges parallel to corresponding edges at a left side of the first conductive portion and a left side of the second conductive portion to form a first narrow slit, a left side of the second radiating portion has a plurality of edges parallel to corresponding edges at a right side of the first conductive portion and a right side of the second conductive portion to form a second narrow slit, and a projection of at least one of the first radiating portion and the second radiating portion overlaps with at least one of the first conductive portion and the second conductive portion.
